(19) United States
(12) Patent Application Publication
(10) Pub. No.: US 2016/0220065 A1
(43) Pub. Date: Aug. 4, 2016

(54) CONTAINER, INCORPORATING A HEATING OR COOLING DEVICE, FOR A FLUID OR SOLID SUBSTANCE

(71) Applicants: Carlo BRUSATORI, Arbedo (CH); Srecko RADOSAVLJEVIC, Bellinzona (CH)

(72) Inventors: Carlo BRUSATORI, Arbedo (CH); Srecko RADOSAVLJEVIC, Bellinzona (CH)

(21) Appl. No.: 14/917,874

(22) PCT Filed: Sep. 9, 2013
(86) PCT No.: PCT/IB2013/001948

§ 371 Date: Mar. 9, 2016

(51) Int. Cl. A47J 36/28; B23P 19/00; F25D 5/00; B65D 81/34; F24J 1/00

(52) U.S. Cl. CPC A47J 36/28; B65D 81/3484; F24J 1/00; F25D 5/00; B23P 19/00

(57) ABSTRACT

The container (1) includes an airtight safety pocket (3) for housing the reaction chamber (4) which generates the heating or cooling effect. The safety pocket is built by folding a sheet inside the container and joining its ends to the edges of the container.

This invention refers to a disposable supple thermal container shaped like an envelope or bag auto-heating or auto-cooling.

It finds use in various applications: in the food, medical, pharmaceutical, free time, recreation, sport, hobby, do-it-yourself, military field as well as for humanitarian assistance and interventions, disaster interventions and so on.

The supple thermal container with embodied internal thermal exchange subject of this invention is shaped like an envelope or bag with double pocket, one to contain the consumer product, the other to safe contain the reaction chamber. The pocket intended to contain the reaction chamber is made by folding a single sheet.

It is a question of a handy disposable dispenser of a consumer product with the need of heating or cooling, exploiting exothermic or endothermic reactions produced by pressure breaking of a bag containing the reaction liquid which comes into contact with the reacting chemical product, said process occurring into the reaction chamber. The peculiarity of this design is that thanks to the double pocket the reaction chamber is fully separated from the consumer product, causing a noticeable safety level dramatically increased in comparison with the products of the know technique already in use with “bag in bag” or “bag in bag in bag” concept.

The container is provided with a double-function valve, that means performing its duty at the same time for the pocket containing the reaction chamber as well as for the pocket containing the consumer product, with the aim to control a possible excessive pressure generated by the chemical reaction or by an incorrect dosage of the chemical product or in case of an incorrect use of the container. The consumption of the product occurs through a spout, protected by a cap or through tear opening.

Thanks to the above-described innovations, the container subject of this invention opposes and solves the drawbacks of the previous products of the known technique.

The Patent EP18966343, even if it introduces for the first time the concept of an endothermic pocket-size supple container, still results too primitive by its design with too many separate compartments inducing handling difficulty and limits to the alimentary safety being the immersed reaction chamber adjacent to the space containing the consumer product.

The Patent Application PCT/IB2011/002223 (and the corresponding European EP2619279) introduces the cascade multi-chamber concept with dedicated spaces one into the other, each dedicated to a defined function: reagent, reaction liquid, reaction chamber, consumer product; nevertheless the alimentary safety is not assured in case of break of the chamber due to overpressure, even with the addition of the valve placed on the bottom because the reaction chamber rips fundamentally on the seams in particular the lateral ones.

The Patent Application PCT WO 2012/113479 represents a pure infringement of the previous one from the point of view on the innovative principle, while from the drawings and the claims it seems to be lacking of the fundamental characteristics of the flexibility, because the claimed elasticity of the material does not necessarily require a flexibility of the packaging and does not exclude its rigidity.

This invention refers instead to a handy supple container with internal thermal exchange for dispensing thermally pre-treated substances, heated or cooled, whose innovative characteristic resides in the fact that the element building the reaction chamber containing the thermal charge is inserted from the side or from the bottom in a safety pocket built by folding a sheet inside the pocket for the consumer product, which is built by the walls of the said container.

The new aim is not to build the envelope or pocket by folding a sheet only to allow interchangeability/recharge but instead essentially to avoid the contact between consumer product and reaction chamber, which are isolated exactly by the interposed pocket containing the reaction chamber.

Unlike the findings of the known technique, which have the reaction chamber immersed in the consumer product to improve the thermal effect, the peculiarity of this idea is that, in our case, the reaction chamber, besides not be immersed in the consumer product, is further shielded by the interposed intermediate safety pocket; in fact the aim is exactly to avoid this through the interposition between consumer product and reaction chamber of a pocket containing the reaction chamber.

More precisely the finding subject of this invention refers to what is described in the claim 1, that is a portable, handy, supple thermal container for self-service consumable preparations, including inside an auto-heating or auto-cooling thermal charge, composed of a pocket, envelope or bag containing the consumer product, separated means containing the reagent and the chemical reaction product, with calibrated release and coupling, means or walls to separate the reaction product and the products for preparation and consumption, characterized by the fact that said thermal supple container with embodied internal thermal exchange, is shaped like an envelope or bag with double pocket, one to contain the consumer product, the other to contain the reaction chamber, the pocket intended to contain the reaction chamber being built by folding a sheet.

Further advantages coming from this invention refer to the description below in the Claims from 2 to 9.

The portable, handy, supple thermal container for self-service consumable preparations it is characterized by the fact that the element building the thermal reaction chamber, which contains the package of the chemical reagents or thermal charge, is placed in a separated safety pocket, built by folding inside the pocket a sheet joining at its ends to the end edges of the said pocket.

Said element building the reaction chamber and containing the thermal charge is inserted from the side or from the bottom in a safety pocket built by folding a sheet inside the pocket for the consumer product, this latter built by the sheet of the walls of said container.

Said element containing the thermal reaction chamber, which contains the package of the chemical reagents, is made by a pocket built by folding inside a point of the pocket an extended strip of a bag-shaped sheet, joining itself at its ends respectively to the end edges of the sheet building the pocket of the consumer product, to obtain said pocket, to build a stand-up container with lateral loading.

In a different way of execution the element containing the thermal reaction chamber, which contains the package on the chemical reagents, is made by a pocket built by joining inside the pocket of the consumer product the edges of a bag-shaped sheet, joining itself at its ends to the end edges of the sheet building the pocket of the consumer product, respectively, to obtain said pocket, to build a container shaped as envelope or bag with bottom loading. The reaction chemical product is in the form of pastilles or capsules or tablets or wafers covered by a protective layer, with calibrated trigger and reaction with gradual, extended, uniform and controlled release of the thermal effect, while the container of the reagent is a bubble of non-evaporable and/or antifreeze liquid, collapsible by calibrated stress along a predetermined breaking line, pressure activated with uniform, progressive and total release of the liquid to generate an improved and increased thermal effect, even if a smaller amount of chemical product is utilised.

The anti-deflagration safety valve of the reaction chamber is bivalent for the pocket of the consumer product and that one containing the reaction chamber and is arranged along a lateral edge of the container to prevent their prevalent lateral break or collapse and can also simply be made by a calibrated draft of the seams arranged on a point along the lateral edge of said pockets.

Said container of the invention is characterized by the fact that said supple container is shaped like a supple, deformable, handy, portable envelope or bag, which can be activated by calibrated stress with independent reaction chamber, isolated, by means of the interposed pocket for the alimentary and/or operational safety.

Said container finds peculiar use and application for self-service consumer preparations in supple, handy and safe packaging for filling with fluid substances of every type and viscosity, particularly foods, also solid, edible and non-edible liquids.

More precisely further characteristics of this finding subject of the invention are related to:

### 1. Form of the Chemical Reagent

Instead of utilising the component as loose powder, by the new finding subject of this invention said chemical component is arranged as pills, pastilles, cylindrical or otherwise shaped capsules, tablets and so on, with the following significant advantages:

a) higher precision of the dosage
b) noticeable reduction of the possible influx of the humidity of the air, being possible to protect the reagent in protected form of tablets with protective layer or capsules or wafers; greater rapidity of execution of the reaction chamber (facilitation of the industrial process); easy preservation in the production process or in case the company provide only the reaction chamber to the customers at their turn producers of the consumer product, who should build themselves the envelope and perform the filling in their premises, receiving the reaction chamber built by a third party;
c) development of the chemical reaction in a more gradual way, allowing the user to contain the envelope in his hand awaiting the consumption, without risk of scalds or nuisance for the too high temperature; instead with the previous system the heat grows quickly and in the time elapsing up to the heat transfer to the consumer product it is annoying to contain in the hand the envelope; furthermore this allows the consumer to choose whether to consume the product at the highest temperature or at a lower for him more agreeable temperature;
d) the final temperature reached by the chemical reaction keeps longer, improving times and ways of consumption of the product.
2. Bubble with Liquid

By the finding subject of this invention the container of the reagent liquid do not break by chance and in the material itself, but in the seam purposely designed, so that also this generates a more gradual, more measurable with respect to the temperature gap to be reached and more complete thermal reaction, being the breaking/opening more specific, more precise, more uniform and fully.

This allows arranging it inside its pocket whether horizontally or vertically, making easier and more precise the manufacturing (the industrial phase).

Furthermore the user can easy understands whether the opening/breaking has occurred or not, while by the executions of the previously known technique, besides the drawback that the bubble of the liquid could even not break, was more difficult to understand immediately whether this had occurred and furthermore between an envelope and the other the feeling could be quite different, so increasing the uncertainty about the occurred breaking and making the use less pleasant.

The adjustment of the seam according to the pressure to be exerted to perform the opening is clearly more precise and more effective.

Our opening/breaking ensures that the whole of the liquid flows out the bubble because it opens on a whole side; this gives the certainty that the whole of the liquid flows out the bubble and goes to interact with the chemical product; instead previously because of the immediate solidification of the chemical product and the possible only partial flow of the liquid from its cell, it happened that not the whole of the liquid went to interact to develop the chemical reaction fully or in the same way or at the same speed, causing a number of uncertainties or greater uncertainty on the effectiveness or possibly also less effectiveness of the reaction itself.

Previously for the other types, besides to make less attractive the product due to the uncertainty induced in the user about the reached temperature and the heating times, this made also uncertain, clearly more difficult or nearly impossible to precisely measure out the thermal gap; all this negatively influencing the use and the marketing of the final product.

Said solution of the invention on the contrary allows adjusting with appreciable precision the thermal gap, allowing creating envelopes with higher thermal gap to individualize/adapt the use to the external meteorological conditions, the custody place, the way of use and the contained product. Furthermore, it serves to check the reached temperatures when we make products that have to become only lukewarm or have a set temperature

### 3. Safety Valve

The safety valve 6 is absolutely positioned on the side of the envelope, that means where it is joined 1′″, preferably in a point situated approximately at the height of ½ of the pocket 3 containing the reaction chamber 4, that means at about ¼ of the length of the external envelope, calculated starting from the basis of the envelope, on both sides or on the left or right side.

By such containers of the known technique, the safety valve was described as additional element, without specifications on the positioning and the relevant efficiency. On the contrary as result of a conscious performed testing it was evident that the envelopes break (in case of incorrect use and therefore of increase of the internal pressure) always laterally. A valve placed on the bottom or on the top of the envelope is then not practically and significantly effective, because the lateral collapse of the seams occurs beforehand.

In the executions of the known technique, the valve was indicated as added/applied element to the reaction chamber; this is useless because the problem of a blowing up comes after the activation of the reaction chamber.

The safety valve can also perform the function of marker if suitably highlighted or coloured.

In this case it serves also to control the sorting for the sale and the transportation and for the delivery to the consumer and to allow him on one hand to differentiate the personal use and the handover to his family, mainly to his children, and on the other increasing the safety level for everybody, avoiding risks of burns and so on. According to the use and then to the conditions of basis temperature one is facing up to, one will choose which container to take with him and use.

In this way one avoids that the envelopes can be mistaken. Furthermore, risks of burns are reduced as well as risks of insufficient heating because of too low external temperature with respect to the heating gap generated by the reaction chamber.

### Envelope Models

1. stand-up envelopes
2. standard envelopes, preferably for food
3. with different colour band according to the desired/optimum thermal gap and/or content
the above distinction is not limiting and the characteristics of the various models are combinable each other.

We give now here below a description of some salient ways of execution of this finding with reference to the attached drawings without moreover depriving of anything the generality of the invention itself.

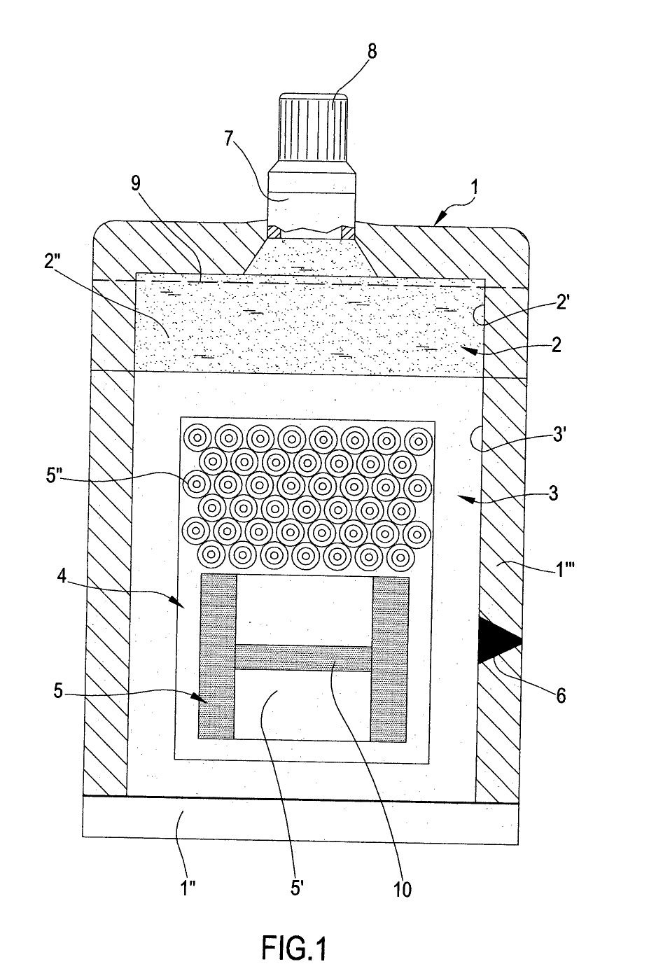

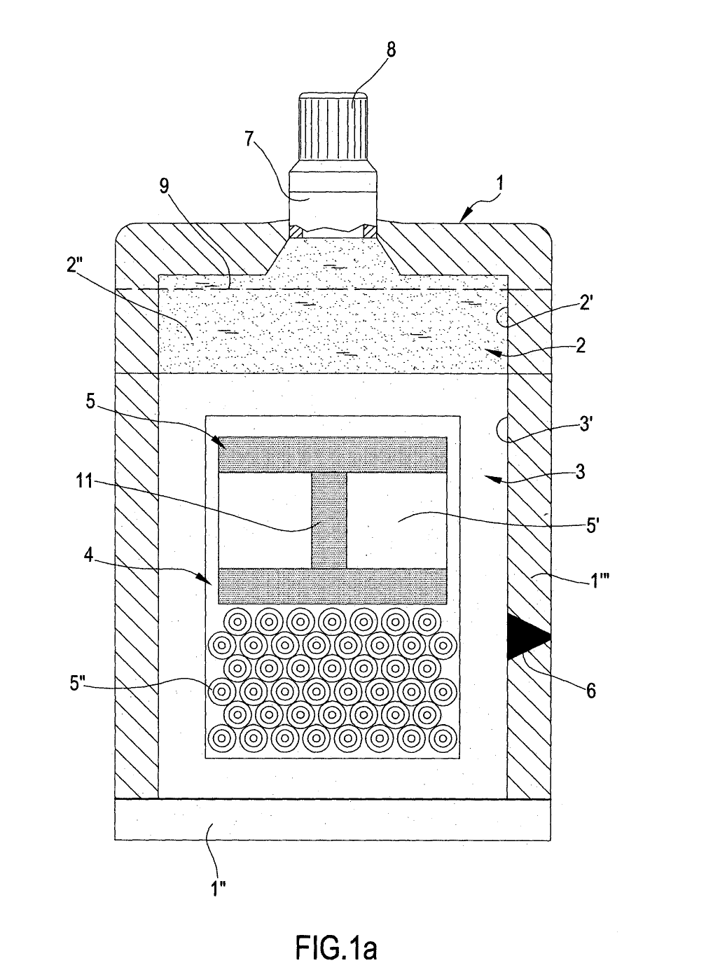

The FIG. 1 shows a view of the container of the invention representing its internal components in the case of lateral insertion of the reaction chamber and bubble with liquid arranged horizontally, in its stand-up way of execution;

The FIG. 1a shows a view of the container of the invention representing its internal components in the case of lateral insertion of the upturned reaction chamber and bubble with liquid arranged vertically, in its stand-up way of execution;

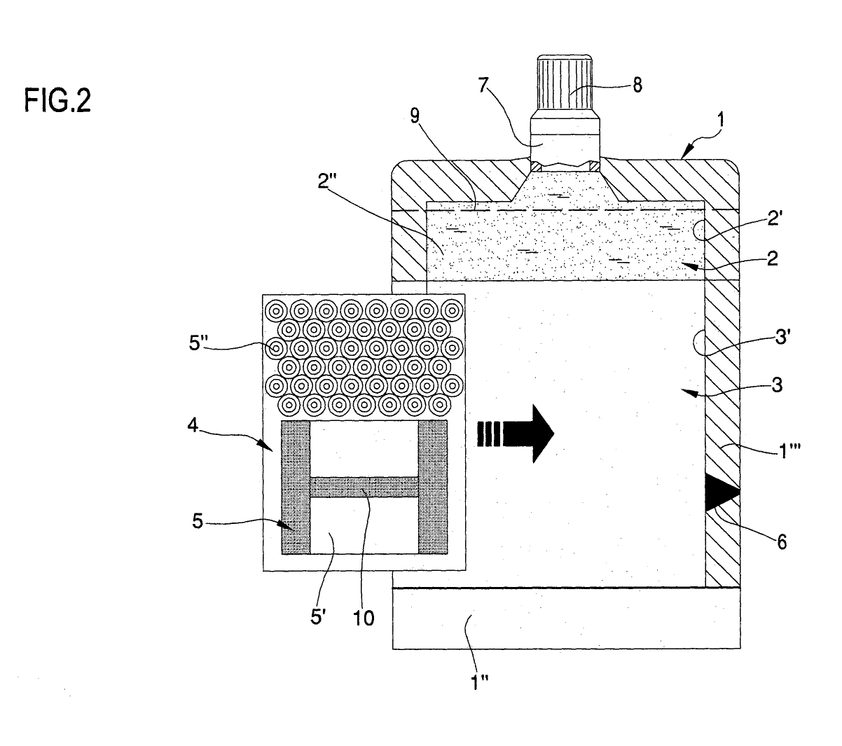

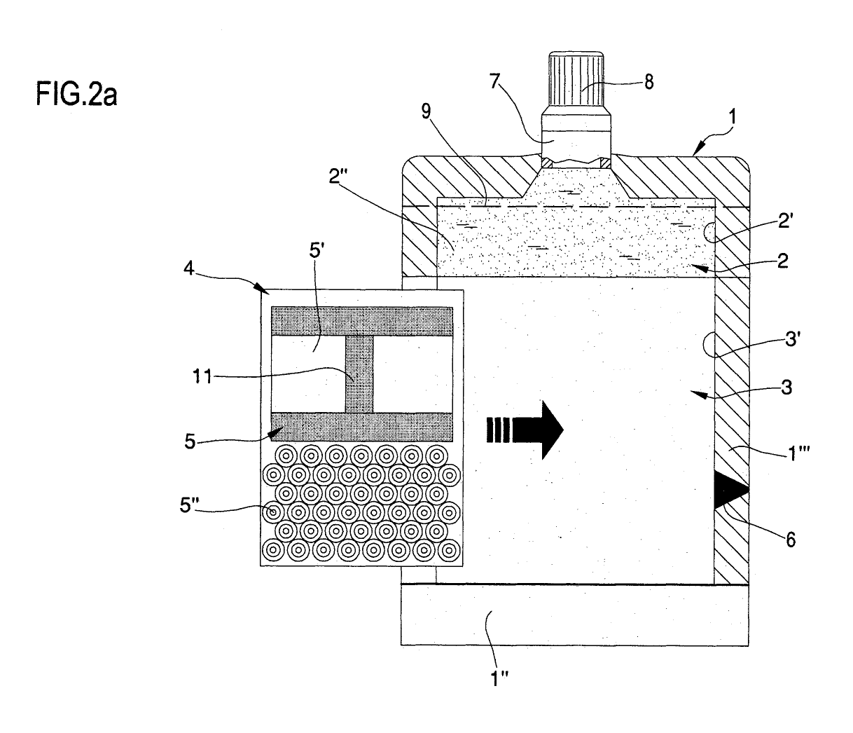

The FIG. 2 shows the way of lateral insertion of the reaction chamber with bubble of liquid arranged horizontally in the dedicated housing pocket of the container of the invention in its stand-up execution way;

The FIG. 2a shows the way of lateral insertion of the upturned reaction chamber with bubble of liquid arranged vertically in the dedicated housing pocket of the container of the invention in its stand-up execution way;

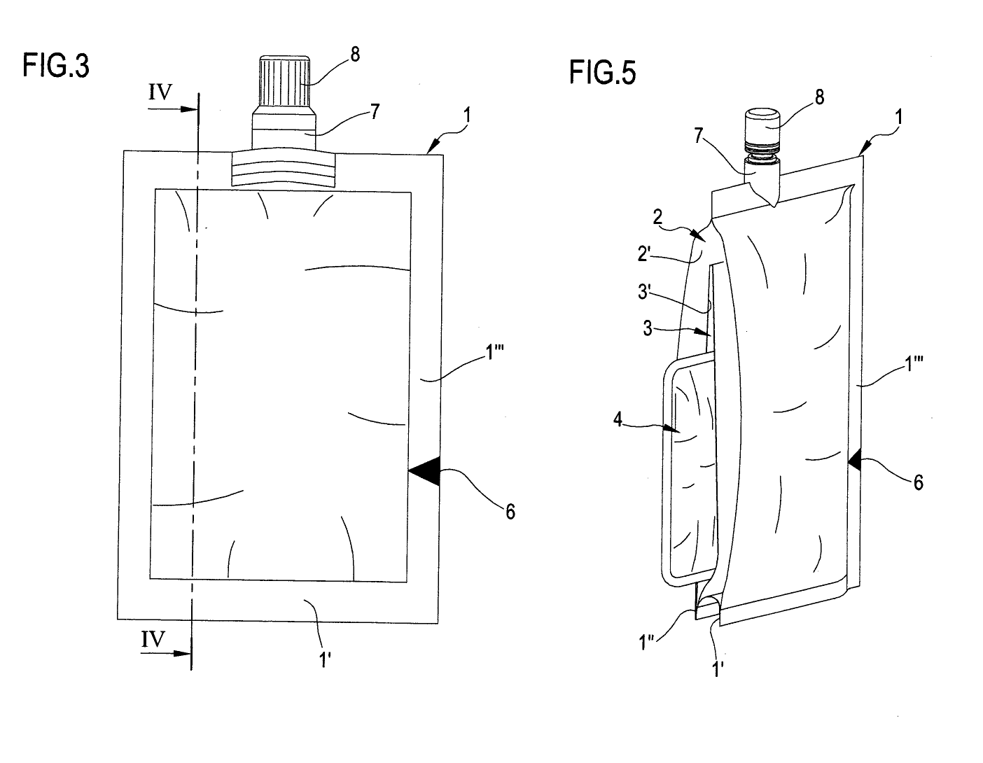

The FIG. 3 highlights a frontal view of the container of the invention with lateral insertion of the reaction chamber in its stand-up way of execution;

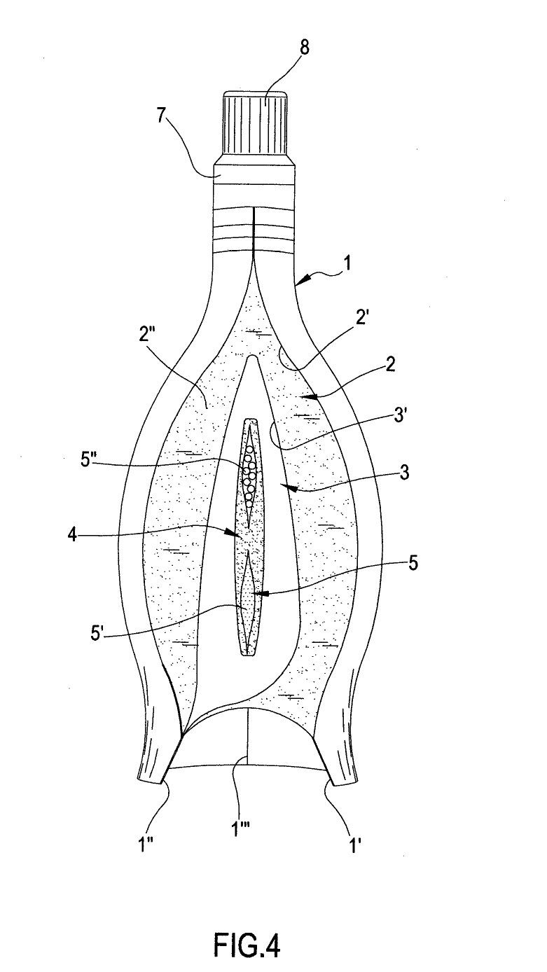

The FIG. 4 represents a lateral cross-section of the previous one along the line IV-IV;

The FIG. 5 describes a cross-section perspective view of the container of the invention with lateral insertion of the reaction chamber into the dedicated housing pocket, in its stand-up way of execution;

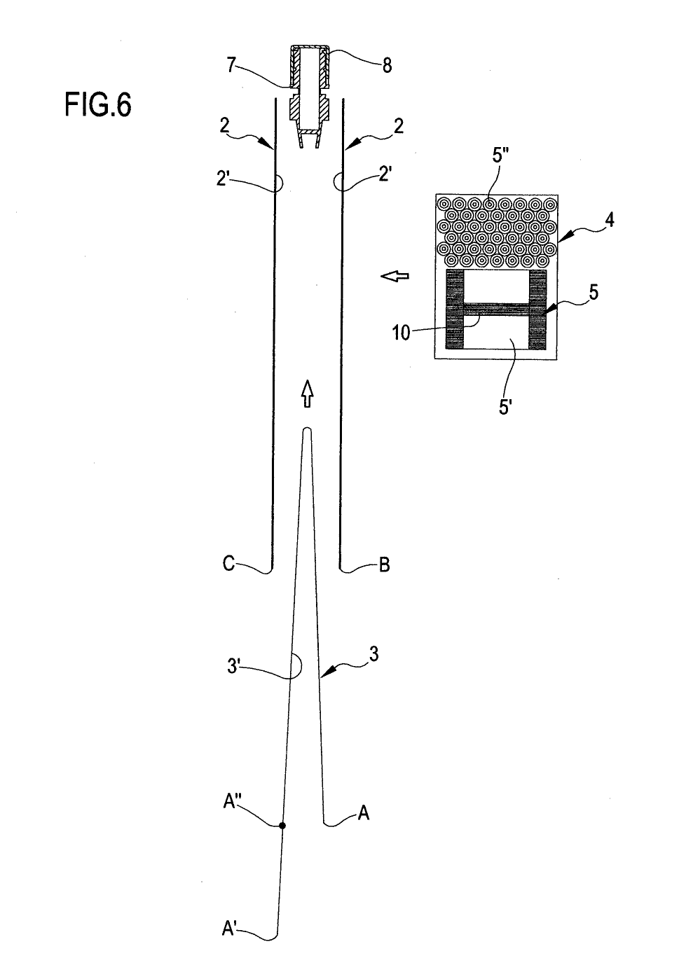

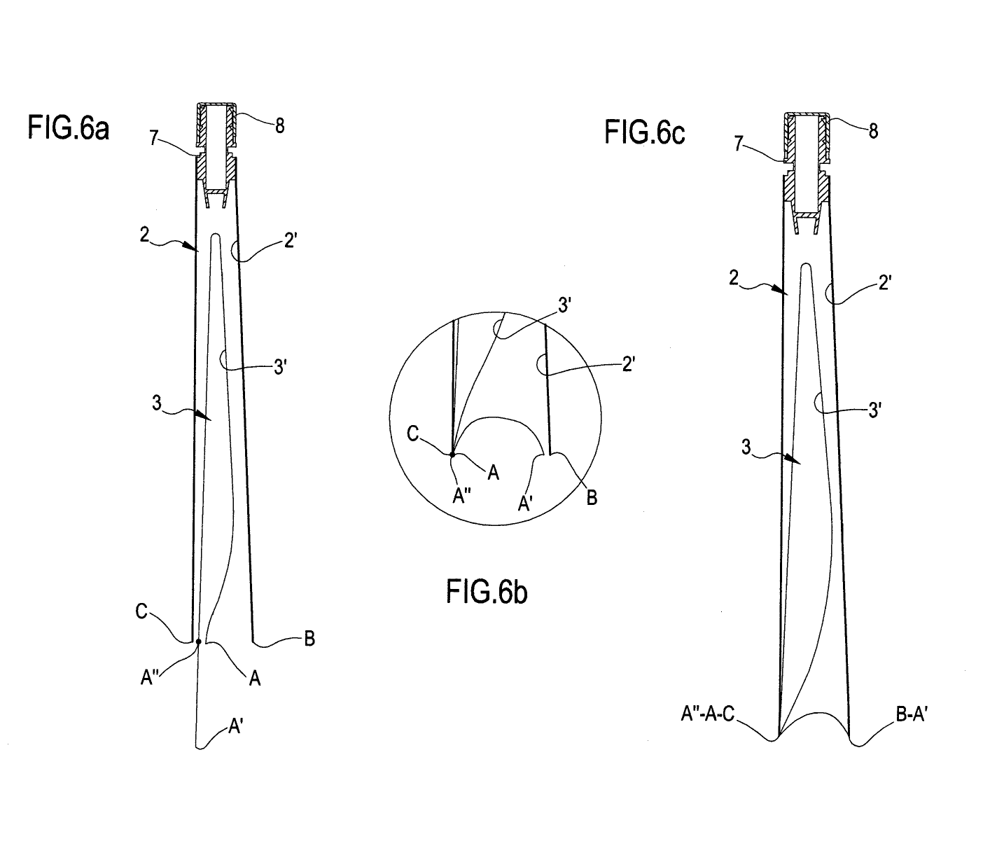

The FIG. 6 shows the sheets for building the pocket of the consumer product with lateral insertion of the reaction chamber, together with the sheet for building the housing pocket of the reaction chamber in its execution way of the stand-up container;

The FIGS. 6a, 6c describe the way to build the housing pocket of the reaction chamber in case Of container with lateral insertion of the reaction chamber in its stand-up way of execution;

The FIG. 6b represents a detail enlargement of the lower part of the previous FIG. 6a highlighting the contact points, seams, of the lower edges of the sheets building the pocket of the consumer product and the airtight housing pocket of the reaction chamber;

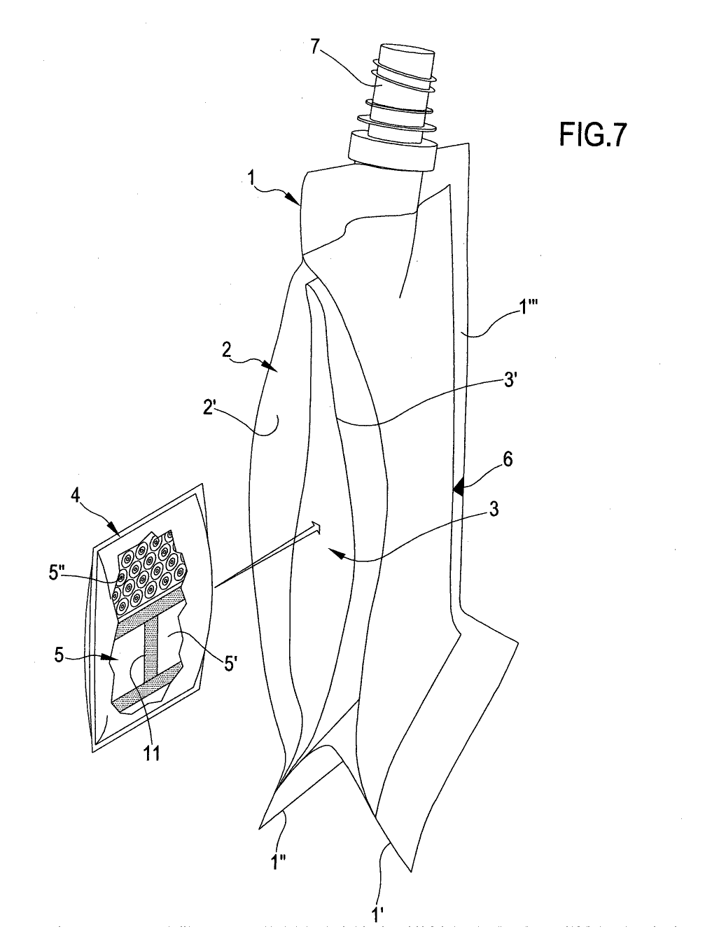

The FIG. 7 represents a cross-section perspective view of the assembly container, pocket for the consumer product, insertion/housing pocket of the reaction chamber, reaction chamber highlighting its components, in its stand-up execution way;

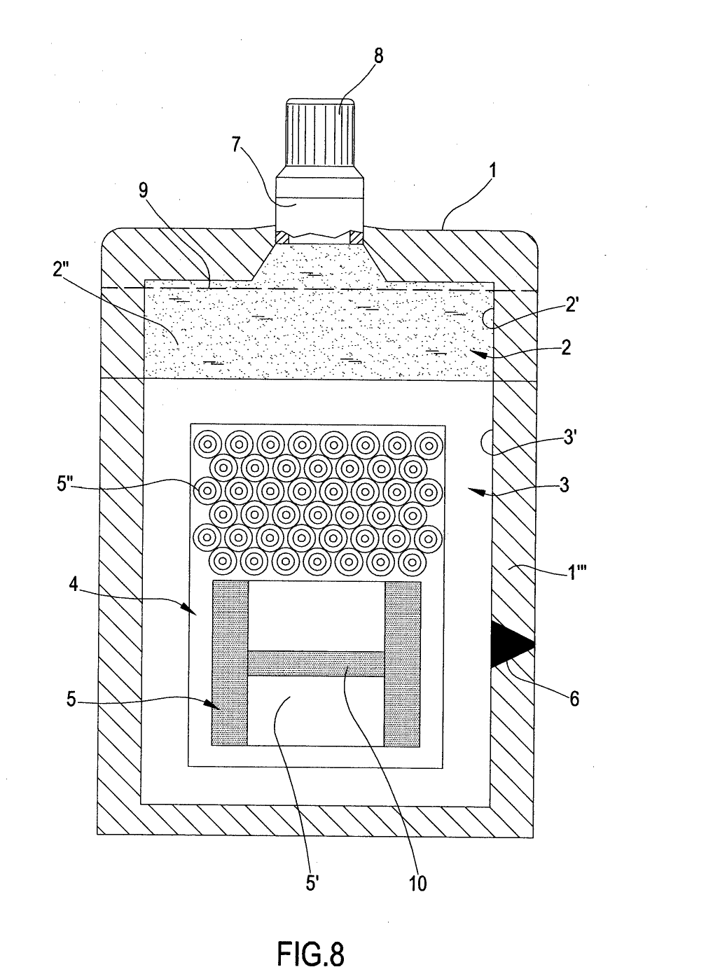

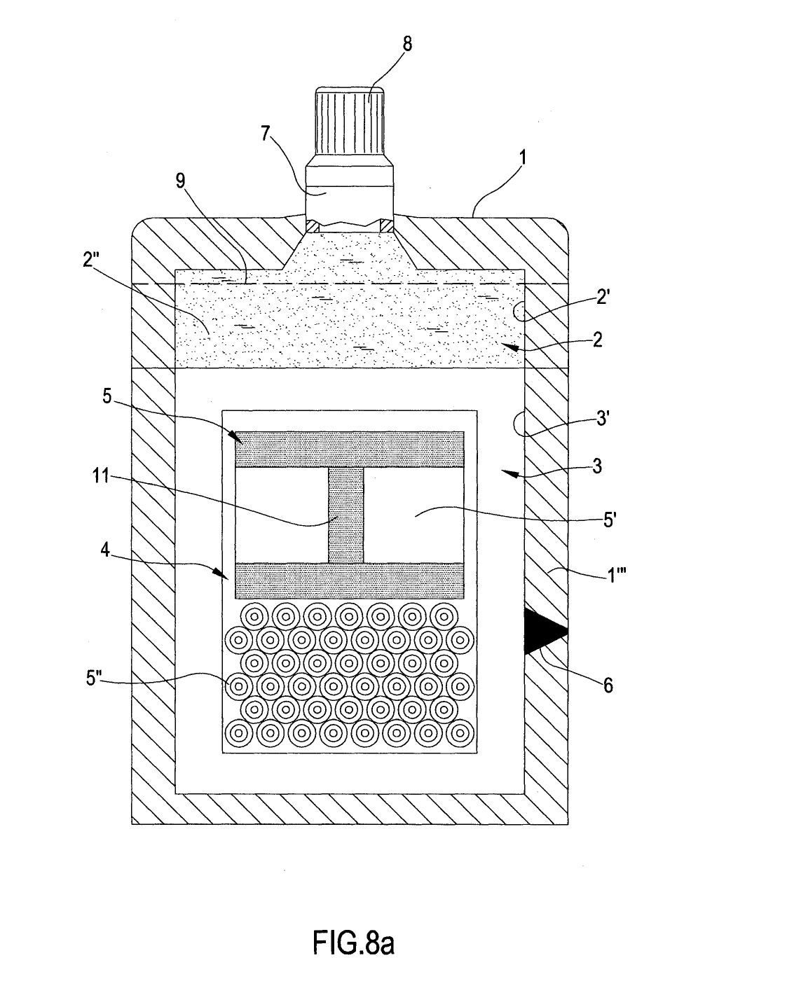

The FIG. 8 shows a view of the container of the invention representing the internal components of the container in case of bottom insertion of the reaction chamber and bubble with reaction liquid arranged horizontally, in its standard way of execution;

The FIG. 8a shows a view of the container of the invention representing the internal components of the container in case of bottom insertion of the upturned reaction chamber and bubble with reaction liquid arranged vertically, in its standard way of execution;

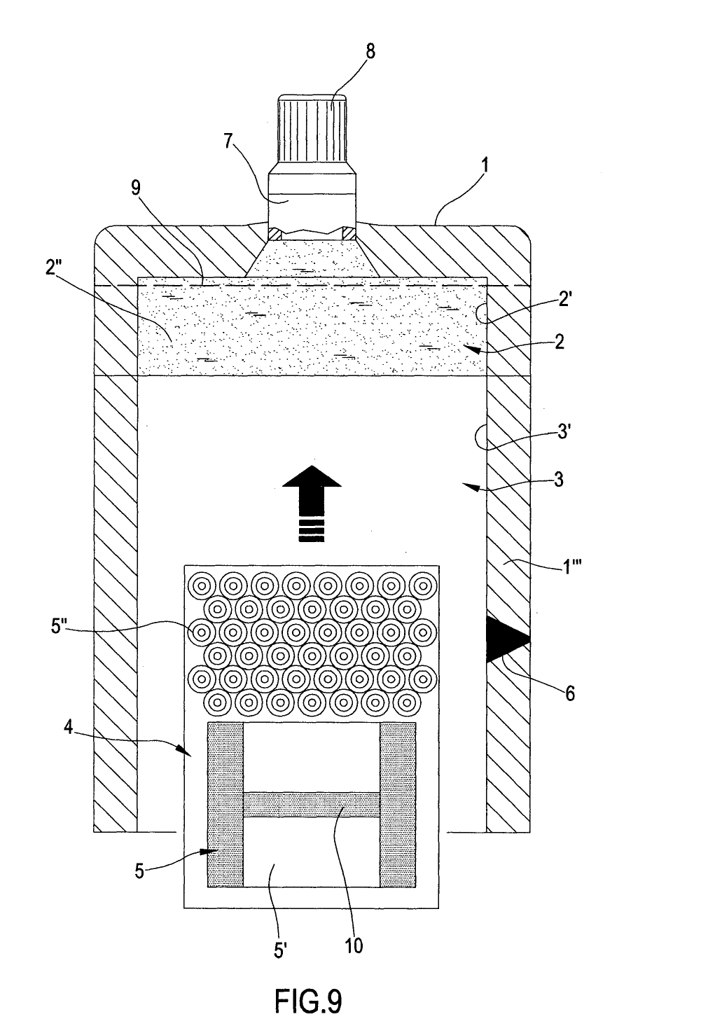

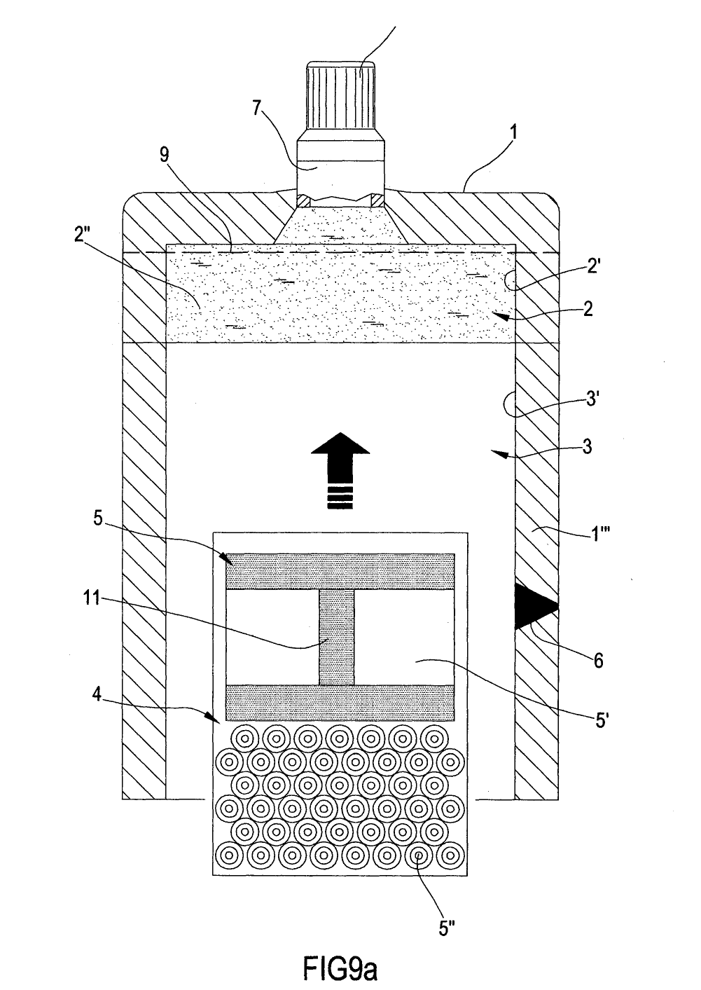

The FIG. 9 illustrates the way of bottom insertion of the reaction chamber with bubble of the reaction liquid arranged horizontally in its dedicated housing pocket of the container of the invention in its standard execution way;

The FIG. 9a illustrates the way of bottom insertion of the upturned reaction chamber with bubble of the reaction liquid arranged vertically in its dedicated housing pocket of the container of the invention in its standard execution way;

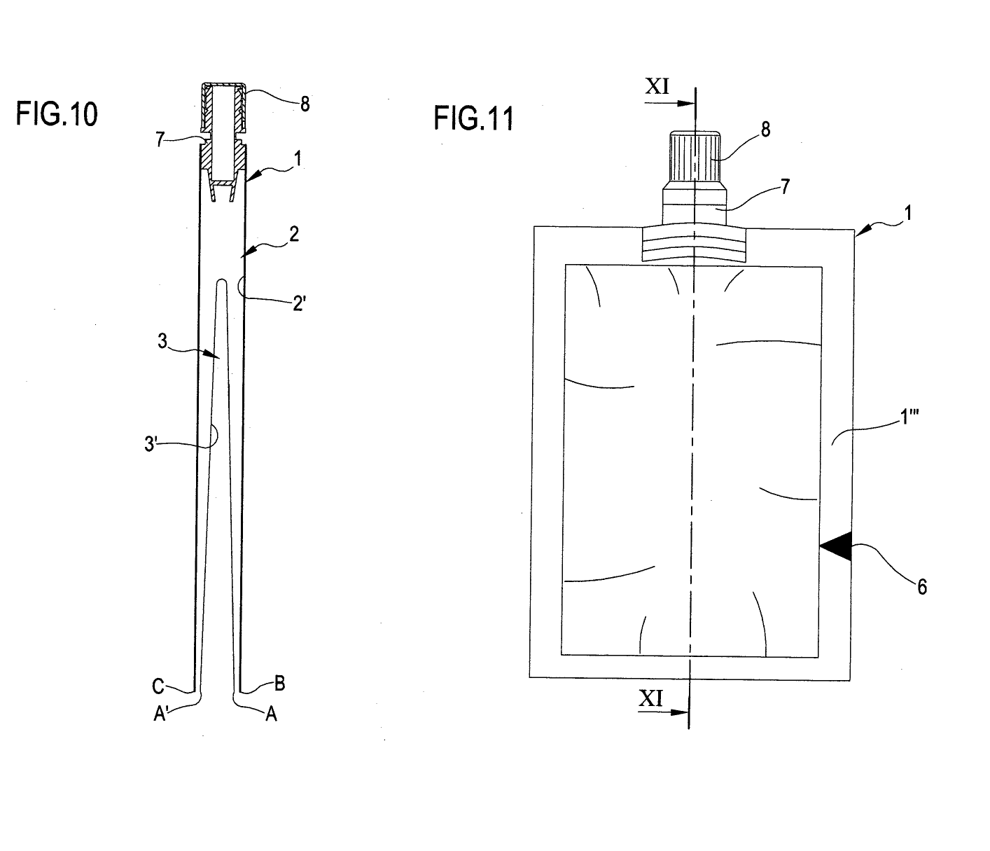

The FIG. 10 shows the sheets for building the pocket of the consumer product of the container of the invention with bottom insertion of the reaction chamber, together with the sheet for building the housing pocket of the reaction chamber, in its standard way of execution;

The FIG. 11 highlights a frontal view of the container of the invention with bottom insertion of the reaction chamber in its standard way of execution;

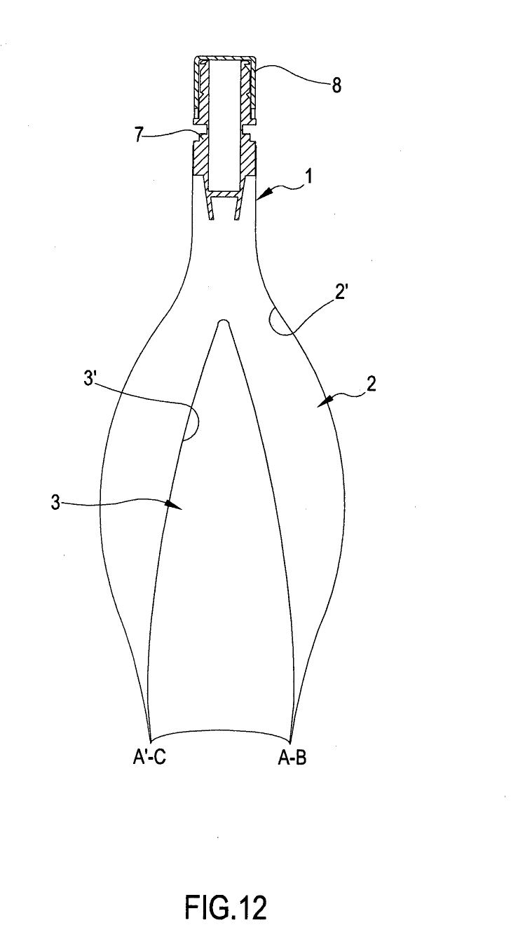

The FIG. 12 represents a lateral cross-section of the previous one along the line XI-XI;

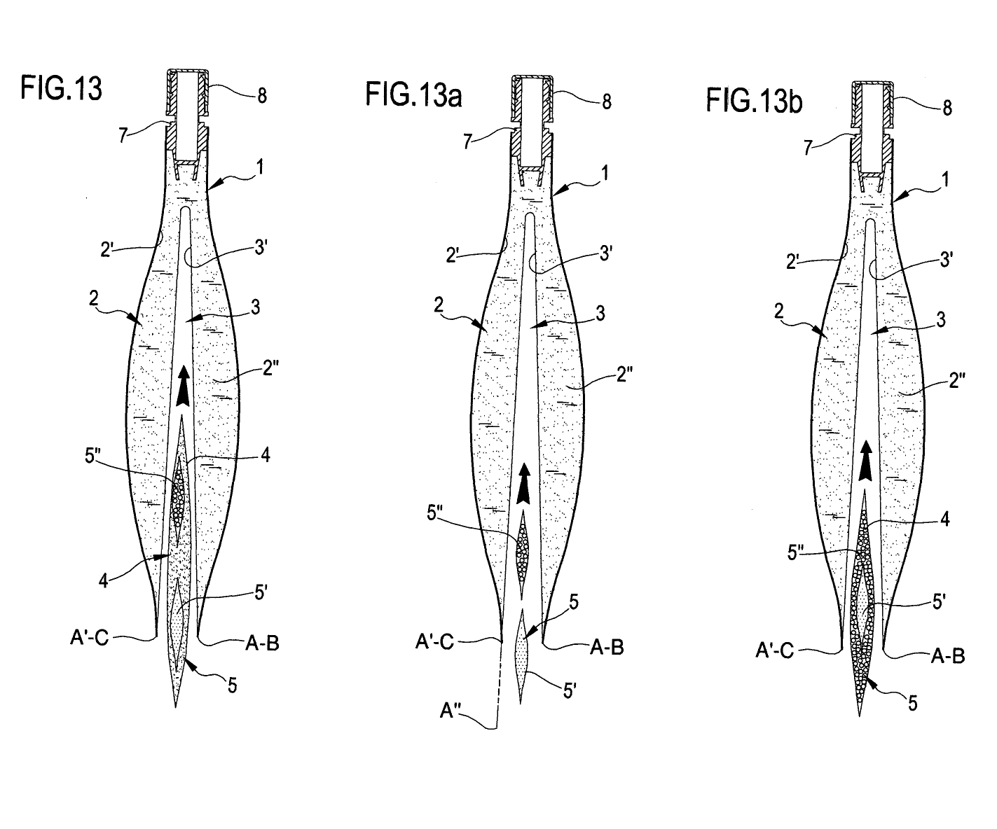

The FIGS. 13, 13a, and 13b show the bottom insertion of the reaction chamber in the housing pocket, respectively in the three possible ways of execution, of reagent and reaction liquid contain in an independent reaction chamber, of loose reagent and reaction liquid housed in a pocket made by the extension of the sheet building the pocket of the consumer product, and of a bubble of reaction liquid contained inside the reagent into the reaction chamber, in case of a container in its standard version;

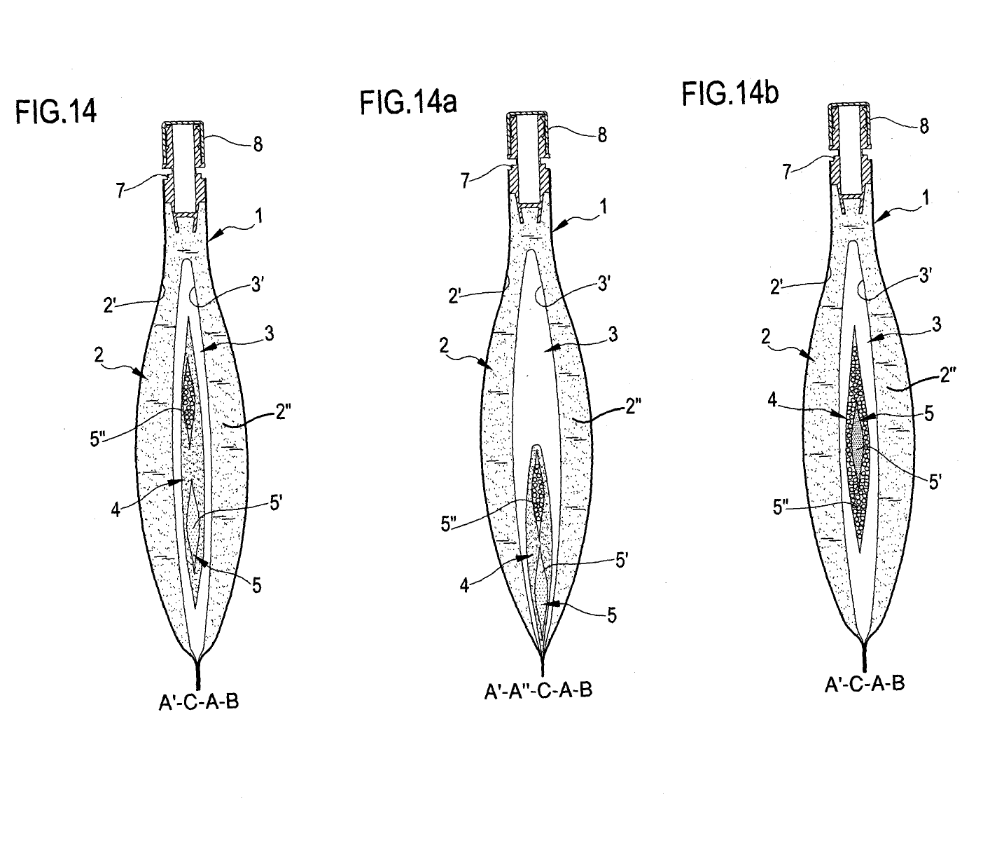

The FIGS. 14, 14a and 14b represent respectively the corresponding previous figures with end edges of the various pockets joined after the completion of the bottom loading of the reaction chamber, and container completed, in case of a container in its standard version.

The supple thermal container 1 with incorporated internal thermal exchange through the lateral or bottom insertion of a reaction chamber 4 is shaped like double-pocket envelope or bag, one pocket 2 containing the consumer product 2″, the other 3 containing the reaction chamber 4.

The pocket 3 intended to contain the reaction chamber 4 is built by folding a single sheet 3′ introduced inside the sheet 2′ building the pocket 2 of the consumer product 2″ and airtight joined to it along the end edges of said sheets 2′, 3′.

It is a matter of a disposable handy dispenser for a consumer product, which needs heating or cooling. This occurs, exploiting endothermic or exothermic reactions generated by pressure breaking of a calibrated bag 5 containing the reaction liquid 5′, which consequently mix itself with the reagent substance 5″ causing the desired endo/exothermic reaction.

The peculiarity of this idea is that thanks to the presence of the double pocket the reaction chamber 4 is fully isolated from the consumer product 2″, which so can not be contaminated because of the interposition of the pocket 3 between the reaction chamber 4 and the pocket 2 containing the consumer product 2″, generating a noticeable safety level dramatically increased with respect to the known containers of the previous type.

The container 1 is provided with a lateral arranged 1′″ double-function valve 6, that means that it performs its function at the same time for the pocket 2 and the pocket 3 with the aim to control a possible excessive pressure generated by the chemical reaction into the reaction chamber 4, or an overheating of the consumer liquid into the pocket 2 with production of vapours and overpressures on the spout 7 and cap 8.

### EXAMPLE 1

### Stand-Up Container

This particular preferred way of execution of the finding subject of this invention shows the superior characteristic to be able to stand like a bottle or carton and to remain upright avoiding the overflow of the consumer product even with open cap and consequent handling and consumption comfort.

The container 1 includes
Pocket 2 for the consumer product built by the sheet 2′;
Consumer product 2″;
Pocket 3 containing the reaction chamber built by folding the sheet 3′;
Reaction chamber 4;
Bag 5 containing the reaction liquid 5′ with pre-set breaking zone 10 or 11;
Reaction liquid 5′;
Chemical reagents 5″ in form of pills, capsules or other;
Cumulative overpressure safety valve 6 purposely serving as marker;
Spout 7 with cap 8;
Draft area or line 9 for tear opening of the container bag;
Seam 1′″ for tight sealing on top and along the lateral outline of the container;
Sealing and supporting feet 1′, 1″ allowing the container to stand upright, built by folding the sheet 3′ whose edges are joined to those of the sheet 2′ of the container of the consumer product.

The container 1 in its stand-up version includes a pocket 2 containing the consumer liquid 2″, housing inside an airtight pocket 3 containing in turn a deformable reaction chamber 4 provided with two compartment 5, 5′, one 5 of whose with airtight walls with controlled collapse. Said reaction chamber 4 is provided of an internal compartment with a reaction element, bag 5 with reaction liquid 5′, with calibrated pressure breaking along its seams 10 or 11 according to their horizontal or vertical arrangement, and with a reagent element 5″, chemical reaction product: the liquid 5′ flows out when the operation is started and comes in contact with the reagent 5″, which is in form of pastilles, tablets, capsules, wafers and similar, triggering the endo/exothermic reaction. FIGS. 1, 1a.

The reaction chamber 4 is introduced laterally into the pocket 3 to create an airtight barrier between reaction products from 5′ and 5″ and consumer product 2″. FIGS. 2, 2a, 5.

The pocket 2 is built by joining (typically seaming) the outline edges 1′, 1″, 1′″ of a sheet 2′. FIGS. 3, 5.

The safety pocket 3, which contains the reaction chamber 4, is arranged interposed inside the pocket 2 containing the consumer product 2″ and it is built by folding a sheet 3′, so that it shows two strips of different length B and A″-A′ respectively; said pocket 3 being built by folding inside the pocket 2 at its point A″ the long edge A″-A′ of said sheet 3′, which joins at its ends A′, A to the end edges B, C of the sheet 2′ building the pocket 2, respectively at A′-B and A-A″-C to build the pocket 3 and at the same time the stand-up container 1. FIGS. 6, 6a, 6b, 6c.

Joining in this way the said edges of the sheets 2′ and 3′, we obtain in the same way the supporting feet 1′, 1″ of the container 1 of the invention in the stand-up version. FIGS. 4, 5, 7.

Into the pocket 3 built in this way the reaction chamber 4 is inserted, provided with the reaction means 5-5′ (bag with reaction liquid) and 5″ (reagent). FIG. 4, (cross-section FIG. 3), 5.

The dotted part on the edges and on the middle of the bag or bubble with liquid 5 of the reaction chamber 4 represents the seams with calibrated collapse. FIGS. 1, 1a, 2, 2a, 6, 7.

A safety valve 6, laterally arranged at about ⅓-¼ of the height of the container 1, serves to avoid any breaking, burs, and violent outflow of the overpressure liquids or vapours and serves at the same time both pockets 2 and 3. FIGS. 1, 1a, 2, 2a, 3, 5, 7.

The safety valve 6 is absolutely positioned on the side of the envelope, that means where it is seamed 1′″, preferably in a point situated approximately at the height of ½ of the pocket 3 containing the reaction chamber 4, that means at about ¼ of the length of the external envelope, calculated starting from the basis of the envelope, on both sides or on the left or right side.

Finally the container 1 is also provided with a spout 7 applied flexibly on the top of the pocket 2 and covered by a closure cap 8 for the consumption of the inside contained product 2″.

In fact, the neck of the spout 7 is not fully covered by the cap 8 because it is applied on the container in a flexible way.

The opening, from which the reaction chamber is then introduced, is shown in the front or perspective views. FIGS. 2, 2a, 5, 6, 7.

In the cross section IV-IV it can be seen how the pocket 3 containing the reaction chamber 4 is arranged on the side because it is just fixed on a single wall. FIG. 3, 4. Furthermore from the cross section it is clear that, contrary to the front views that could be misleading, because it could appear that on the side of the pocket 3 with the reaction chamber 4, inside the container 1, the pocket 2 containing the consumer product 2″ should not be present; in fact the pocket′ 2 is present on both sides like a normal envelope. FIG. 4, 6a, 6c.

Always with reference to the stand-up version we specify that the pocket 3 containing the reaction chamber 4, on the side opposite to its seam to the internal wall of the container 1, that means to the internal wall 2′ of the pocket 2 containing the consumer product 2″, low, that means at the bottom of the container 1, shows one of its internal walls 3′ of the sheet 3, building the pocket 3 for the reaction chamber 4, of longer length A″-A′, which is folded and seamed on its folding point A″ to itself together with its other wall A together with the wall C of the pocket 2, while the remaining longer part in excess A″-A′ goes on building the arch bottom of the stand-up envelope, which is joined by seaming of its end edge A′ on the other side to the external and internal wall B of the pocket 2 of the container 1, building a whole with the seam and building the arch bottom of the container 1, allowing meanwhile the lower edges 1′, 1″ to build its supporting basis which lets the whole container 1 stand upright when placed on a horizontal surface. FIGS. 6, 6a, 6b, 6c, 7.

The pocket 3 containing the reaction chamber 4 is then arranged on the side because is just fixed on an only wall. FIG. 4, 6a, 6b, 6c.

It is also worth to highlight that the reaction chamber 4 can be arranged also upturned; in fact according to the type of consumer product or to other needs (in particular for the stand-up envelope where it is expected that the user activates it for the consumption and instead of holding it in hand, puts it on the table waiting for the completion of the thermal reaction and the subsequent stand-by consumption); the fact to have the reaction chamber in upturned position, that is with the liquid on the upper part which will go down by gravity on the chemical product at the time of the break of the separation barrier inside the reaction chamber, can further ease the contemporaneous and homogenous quicker diffusion of the liquid on the chemical product, effect which can be already obtained in itself shaking the container, as recommended in the directions for use and because of the pastilles have already the aim and the effect to favour said homogeneity and contemporaneity of generation and diffusion of the thermal effect.

For what concerns the safety valve 6, its various functions and the use of the container we refer to what was said above.

### EXAMPLE 2

### Standard Container as Envelope or Bag

It includes the following elements:
Pocket 2 for the consumer product built by the sheet 2′;
Consumer product 2″;
Pocket 3 containing the reaction chamber built by the sheet 3′;
Reaction chamber 4;
Bag 5 containing the reaction liquid 5′ with preset breaking zone 10 o 11;
Reaction liquid 5′;
Chemical reagents 5″ in form of pastilles, capsules or other;
Cumulative overpressure safety valve 6, purposely serving also as marker;
Spout 7 and cap 8;
Draft area or line 9 for tear opening of the container bag;
Airtight seam 1′″ of the container;
Edges B-C and A-A′ respectively of the pockets of the consumer product and of the container of the reaction chamber, building first the opening for the introduction of the reaction chamber from bottom and then the seal for the subsequent closure.

By this execution of the standard envelope container which is preferably suitable for foods or other creamy or sticky products, alimentary or not, the reaction chamber is fixed (seamed, then double seaming point) on both the walls of the pocket 3 containing the reaction chamber 4. FIGS. 10, 12, (cross-section XI-XI FIG. 11), 13, 13a, 13b, and 14, 14a, 14b.

Purpose of the intermediate pocket 3 containing the reaction chamber 4 is not really to obtain interchangeable cartridges: that is the new aim is not to make an interposed envelope just to allow interchangeability/recharge, but mainly to avoid contact between consumer product and reaction chamber. FIGS. 8, 8a, 9, 9a.

As described in the FIGS. 8a, 9a, the reaction chamber 4 can be also arranged upturned, this is also possible for the standard container.

Also for the standard envelope container subject of this way of execution, the pocket 3 intended to house the reaction chamber 4 is built by folding a sheet 3′, whose edges A-A′ go first to join to the edges B-C of the sheet 2′ building the pocket 2 of the consumer product and then to join all together with airtight closure B-A-A′-C, after the reaction chamber 4 has been introduced from bottom and arranged. FIGS. 10, 12, (cross-section XI-XI FIG. 11), 13a, 13b, 14, 14a, 14b.

Also by this way of execution of the invention the container is provided with a double-function valve 6, that means that it performs its function at the same time for the pocket 2 and the pocket 3 with the aim to control a possible excessive pressure, generated by the chemical reaction in the reaction chamber 4, preventing its deflagration in case of incorrect use of the product or incorrect dosage of the chemical reagent. FIGS. 8, 8a, 9, 9a, 11.

It is interesting to note also in this version, that the secondary use of the valve 6 is that of refracting coloured marker replacing the various bands of different colour used according to the desired/optimum thermal gap or other coloured visual indicator to differentiate the heating power, so that to “customize” and make more effective and more safe the use according to the basis temperature.

### Intended Utilization

The container of this invention is a supple, portable, handy and safe container and is suitable for a number of uses and applications, in particular as disposable dispenser of a consumer and/or necessity product, like soft drinks and drinkables, restoring, energy-giving, tonic, refreshing beverages and liquid foods for sport and free time; drinkable and liquid foods, sauces, creams and seasonings; baby foods, use as baby's bottle and dispensers by nourishing; cosmetics, body care applications, beauty, thermal and wellbeing treatments; ready-to-use medicine packets for drugs, therapeutics, adjuvant drugs, administrations of therapeutic preparations and alimentary integrators for the health; provisioning rations and sanitary equipment for the Army; products, provisioning and first-aid goods for the disaster intervention civil force and the humanitarian interventions; industrial and construction products (like adhesives, sealing means, putties, plasters, paints, compounds and so on); hobby and do-it-yourself products, needing a minimum or preset temperature for their application/use.

Furthermore, said container replaces the thermal envelope in the supermarkets being able to carry frozen goods for a certain time from the dealer to the consumer, for instance milk, drinks or other goods.

Finally, said container is suitable for future applications for packaging for aerospace use: drinks, liquid and soluble foods, drinkable or sanitary water, creams, medicines and so on.

The finding subject of this invention represents a radical innovation in the field of the handy dispensers of “ready-to-carry, ready-to-use” preparations, both from the technical point of view for the introduced increased safety means and for the introduced revolutionary effects on the consumer habits and on the market.

1. Portable, handy, supple thermal container (1), for self-service consumable preparations, including inside an auto-heating or auto-cooling thermal charge, composed of a first pocket, envelope or bag (2) containing the consumer product (2″), a reaction chamber (4) containing a reagent (5″) and a chemical reaction product (5′), with calibrated release and coupling, means or walls to separate the reaction product from the products for preparation and consumption,
said thermal supple container (1) with embodied internal thermal exchange being shaped like an envelope or bag with double pocket, a first pocket (2) to contain the consumer product (2″), a second pocket (3) to contain the reaction chamber (4), the second pocket (3) intended to contain the reaction chamber being built by folding a sheet (3′),
said thermal supple container (1) having a top side carrying a spout (7), a bottom side opposite to said top side and two lateral sides extending between said top side and said bottom side, characterized in that said thermal supple container (1) comprises a safety valve (6) intended to control a possible excessive pressure generated in the reaction chamber (4),
said safety valve acting on both the first and second pockets (2, 3), and in that said safety valve (6) is arranged along at least one of said lateral sides of the container (1) to prevent the prevalent lateral breaking or collapse of the said pockets.

2. Portable, handy, supple thermal container (1) according to claim 1, characterized in that said safety valve (6) is positioned along said at least one lateral side at a point situated approximately at the height of ½ of said second pocket (3) intended to contain the reaction chamber, that means at about ¼ of the length of said container (1), starting from its bottom side.

3. Portable, handy, supple thermal container (1) according to claim 1, characterized in that said safety valve (6) is made by a calibrated draft of the seams arranged at a point along said lateral side of the first and second pockets (2) and (3) of the container (1).

4. Portable, handy, supple thermal container (1) according to claim 1, characterized in that said reaction chamber (4), which contains said reagent (5″) and said chemical reaction product (5′) is housed in said second pocket (3), which is built by a sheet (3′) folded inside the first pocket (2) and joined at its end to the end edges of said first pocket (2).

5. Portable, handy, supple thermal container (1) according to claim 1, characterized in that the reaction chamber (4) is inserted from the side or from the bottom into said second pocket (3).

6. Portable, handy, supple thermal container (1) according to claim 1, characterized in that the chemical reaction product (5″) is in form of pastilles or capsules or tablets or wafers covered by a protective layer, which allows to calibrate far more better the calibrated trigger and the degree of reaction (thermal gap), and with gradual and faster extended, uniform and controlled release of the thermal effect.

7. Portable, handy, supple thermal container (1) according to claim 1, characterized in that, and that the reagent (5′) is housed in a container (5) and in that the container (5) of the reagent (5′) is a bubble of non-evaporable and/or antifreeze liquid, collapsible by calibrated stress along a predetermined breaking line.

8. Method for manufacturing a portable, handy, supple thermal container (1) according to claim 1, comprising the steps of:
folding a first sheet (2′) so as to obtain to a first pocket (2) having two strips of the same length ending with respective end edges (B, C);
folding a second sheet (3′) so as to obtain a second pocket (3) having two strips of different length ending with respective end edges (A, A′);
inserting the folded second sheet (3′) into the folded first sheet (2′);
joining the end edge (A) of the shorter strip of the folded second sheet (3′) to the end edge (B) of a first strip of the first folded sheet (2′);
joining an intermediate point (A″) of the longer strip of the folded second sheet (3′) to the end edge (C) of the second strip of the first folded sheet (2′);
joining the end edge (A′) of the longer strip of the folded second sheet (3′) to the end edge (B) of the first strip of the first folded sheet (2′) and to the end edge (A) of the shorter strip of the folded second sheet (3′), thereby obtaining a pair of supporting feet (1′,1″);
laterally inserting the reaction chamber (4) into said second pocket (3), built by said folded second sheet (3′).

9. Method for manufacturing a portable, handy, supple thermal container (1) according to claim 1, comprising the steps of:
folding a first sheet (2′) so as to obtain to a first pocket (2) having two strips of the same length ending with respective end edges (B, C);
folding a second sheet (3′) so as to obtain a second pocket (3) having two strips of the same length ending with respective end edges (A, A′);
inserting the folded second sheet (3′) into the folded first sheet (2′);
joining the end edge (A) of a first strip of the folded second sheet (3′) to the end edge (B) of a first strip of the first folded sheet (2′);
joining the end edge (A′) of the second strip of the folded second sheet (3′) to the end edge (C) of the second strip of the first folded sheet (2′);
inserting from the bottom the reaction chamber (4) into said second pocket (3), built by said folded second sheet (3′).

10-13. (canceled)

14. A portable, supple thermal container which comprises an envelope for containing a consumable preparation and defining a sealed pocket therewithin;
a thermal exchange bag in said sealed pocket;
a safety valve in communication with said envelope and said sealed pocket; and
a spout in communication with said envelope for dispensing the consumable preparation.

15. The thermal container according to claim 14 wherein the thermal exchange bag contains reagents for initiating an exothermic reaction.

16. The thermal container according to claim 14 wherein the thermal exchange bag contains reagents for initiating an endothermic reaction.

17. The thermal container according to claim 14 wherein the thermal exchange bag is activatable by applied pressure.
